(19) United States
(12) Patent Application Publication
(10) Pub. No.: US 2013/0044370 A1
(43) Pub. Date: Feb. 21, 2013

(54) DEVICE AND METHOD FOR SCANNING AN OBJECT AND A MICROSCOPE

(71) Applicants: Volker Seyfried, Nussloch (DE); Bernd Widzgowski, Dossenheim (DE); Holger Birk, Meckesheim (DE)

(72) Inventors: Volker Seyfried, Nussloch (DE); Bernd Widzgowski, Dossenheim (DE); Holger Birk, Meckesheim (DE)

(73) Assignee: Leica Microsystems CMS GmbH, Wetzlar (DE)

(21) Appl. No.: 13/578,608

(22) PCT Filed: Feb. 11, 2011
(86) PCT No.: PCT/EP2011/052031

§ 371 Date: Sep. 21, 2012

(30) Foreign Application Priority Data
Feb. 12, 2010 (DE) 10 2010 007 728.3

(51) Int. Cl. G02B 21/33

(52) U.S. Cl. 359/385

(57) ABSTRACT

The invention relates to a device for scanning an object comprising a focusing lens system (30) which focuses an illuminating light beam (24) onto a region of the object to be analyzed. An actuator assembly is coupled to the focusing lens system (30) and moves the focusing lens system (30) in accordance with a predefined scanning pattern transversely to the cecenternter axis of the illumination light beam (24) in a reference position of the illumination light beam (24). A front glass (38) is disposed downstream of the focusing lens system (30) viewed in the direction of the illuminating light beam (24). An internal immersion medium (40) is disposed between the focusing lens system (30) and the front glass (38). An external immersion medium (48) can be introduced between the front glass (38) and the object.

### CROSS-REFERENCE TO RELATED APPLICATIONS

The present application is the U.S. national phase of International Application No. PCT/EP2011/052031 filed Feb. 11, 2011, which claims priority of German Application No. 10 2010 007 728.3 filed Feb. 12, 2010, the entirety of which is incorporated herein by reference.

### FIELD OF THE INVENTION

The invention relates to a device and a method for scanning an object. The device has a focusing lens system that focuses an illuminating light beam on an area of the object that is to be examined. The invention further relates to a microscope that is embodied in the manner of a scanning microscope, a laser scanning microscope and/or a confocal microscope, and comprises the device for scanning the object.

### BACKGROUND OF THE INVENTION

A scanning microscope for examining an object, particularly a specimen, basically has at least one light source that produces an illuminating light beam. The illuminating light beam is deflected by means of a scanning unit and then focused on the object by means of a focusing lens system. In known microscopes, the scanning unit has two or more reflectors that can be adjusted by means of adjusting elements associated with the reflectors. Adjusting the reflectors causes a focusing area, which may be for example in the form of a point or line, to be moved on or in the object. Preferably, during the scanning of the object, the focusing area is moved within a scanning field such that the entire scanning field can be optically scanned. Detection beams emanating from the object and produced, for example, by fluorescence effects in the illuminated area of the object can then be deflected onto a detector unit and picked up by means of the latter.

DE 10 2004 042 913 A1 describes a device for scanning an object in which a sliding carriage drive moves an objective lens synchronously with a microscope stage. The optical scanning takes place during the movement of the microscope stage.

DE 10 2004 059 778 A1 describes a projection objective for immersion lithography in which a front glass is used to protect the focusing lens system. An internal immersion medium is disposed between the focusing lens system and the front glass.

It is known from DE 101 52 609 A1 to move an objective of a scanning microscope transversely to the optical axis. There is no movement transversely to the direction of a down-lighting illuminating light beam.

### SUMMARY OF THE INVENTION

The problem of the present invention is to provide a device and a method for scanning an object and a microscope which make it possible to obtain a large numerical aperture and particularly high resolution at low cost.

The problem is solved by the features of the invention described herein. Advantageous embodiments are recited in the present specification.

According to a first aspect, the invention is characterised in that an internal immersion medium is disposed between the focusing lens system and a front glass which is arranged downstream of the focusing lens system, viewed in the direction of the illuminating light beam. The focusing lens system is coupled to an actuator assembly that moves the focusing lens system according to a predefined scanning pattern transversely to a center axis of the illuminating light beam in a reference position of the illuminating light beam.

Preferably, the focusing lens system is moved in two different directions within a plane, particularly perpendicularly to the centre axis of the illuminating light beam. This serves to scan a predefined scanning field on or within the object. The object is preferably a specimen, particularly a tissue sample.

Without the internal immersion medium, total reflections occur from specific angles at the interface between the cover glass and the air. The internal immersion medium makes it possible for light beams from the sample, particularly detection light beams, to enter the focusing lens system, particularly a lens of the focusing lens system, at much flatter angles than if there were no internal immersion medium. At the same time, the numerical aperture of the device as a whole is increased. Suitable internal immersion media include oil, water or glycerol, or mixed media containing at least one of the above-mentioned media.

Preferably, the gap between the focusing lens system and the front glass is filled, particularly completely, with the internal immersion medium, so that no transitions from the focusing lens system to the air, from the immersion medium to the air and/or from the front glass to the air are formed along the beam path of the illuminating light. This preferably helps to make the numerical aperture and the resolution particularly great.

Creep or dissolving of the immersion medium can advantageously be prevented by containing the immersion medium with a membrane perpendicularly to the illuminating light beam. This is especially advantageous when the internal immersion medium has a particularly low viscosity. One surface of the membrane may be aligned parallel to the center axis of the illuminating light beam, or else may be arranged obliquely or diagonally thereto or of domed or dished configuration.

In an advantageous embodiment, the internal immersion medium has a predefined viscosity which is preferably particularly high or particularly low. A particularly low viscosity has the advantage that the internal immersion medium only slightly affects the lens movement, which assists with the precise controllability of the moving focusing lens system. A particularly high viscosity, on the other hand, has the advantage that even during a particularly rapid movement of the focusing lens system, for example in the range of a resonating frequency, the internal immersion medium is prevented from escaping from the interstice between the front glass and the focusing lens system, particularly when no membrane is provided.

In another advantageous embodiment, the surfaces of the front glass and/or the focusing lens system which are in contact with the internal immersion medium have a predefined roughness. The predefined roughness is preferably particularly high or particularly low. The advantage of particularly high roughness, which on the one hand should be only microscopic, but on the other hand should be capable of being produced by deliberate formation of a profile in the corresponding surface, is that the internal immersion medium adheres particularly well to the front glass or the surface of the focusing lens system. By contrast, the advantage of a particularly smooth surface of the focusing lens system or the front glass is that the focusing lens system and the front glass can be brought very close together. In this case, an immersion medium with a very low viscosity is preferably used. In fact, if the distance between the focusing lens system and the front glass is significantly less than the wavelength of the illuminating light used, the refractive index of the medium located between them, particularly the immersion medium, has only a slight to negligible effect. Alternatively or additionally, particularly when the above-mentioned distance is particularly short, it is advantageous if the surfaces of the front glass or the focusing lens system that are in contact with the internal immersion medium are hardened. This can prevent damage and/or wear on the surfaces that move relative to one another. By contrast, these surfaces may also be made particularly soft, so that no damage occurs if there is unintended contact between the front glass and the focusing lens system.

According to a second aspect the invention relates to a microscope in the manner of a scanning microscope, a laser scanning microscope and/or confocal microscope which encompasses the device for scanning the object.

Moreover, according to a third aspect, the invention relates to a method for scanning the object. The invention is characterised in that the immersion medium is introduced between the focusing lens system and the specimen such that the focusing lens system and the specimen are in contact with the immersion medium. Alternatively, the specimen may be covered with a cover glass and/or the focusing lens system may be covered by the front glass. Between the front glass and the specimen, an external immersion medium can then be provided instead of or in addition to the internal immersion medium between the focusing lens system and the front glass. The external immersion medium may correspond to the internal immersion medium in its nature or may be different. The surfaces that are in direct contact with the external immersion medium may then be embodied to correspond to the surfaces that are in direct contact with the internal immersion medium.

### BRIEF DESCRIPTION OF THE DRAWING VIEWS

Embodiments exemplifying the invention are described in more detail hereinafter by reference to schematic drawings, wherein:

FIG. 1 shows a first embodiment of a device for scanning an object with an internal immersion medium,

FIG. 2 shows the first embodiment of the device for scanning an object with a cover glass, the internal immersion medium and an external immersion medium,

FIG. 3 shows a second embodiment of the device for scanning the object,

FIG. 4 shows the device for scanning an object in a confocal microscope, and

FIG. 5 shows a third embodiment of the device with the external immersion medium.

### DETAILED DESCRIPTION OF THE INVENTION

Elements having the same structure or function are designated by the same reference numerals across all the Figures.

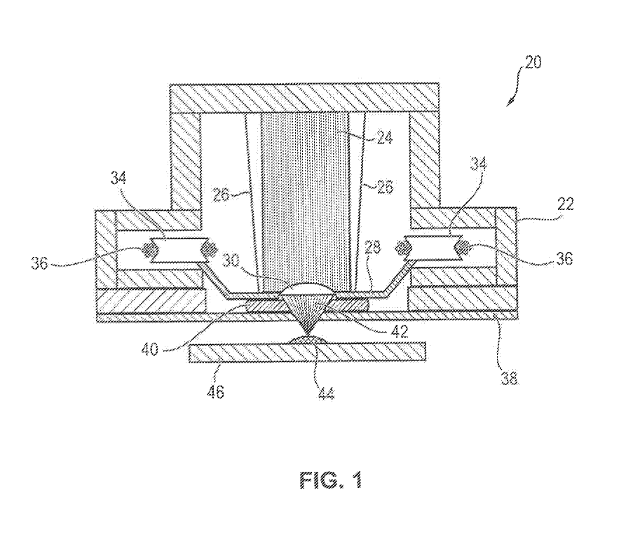

FIG. 1 shows a scanning unit 20 for a microscope, which can also be referred to as a device for scanning an object. The scanning unit 20 has a housing 22 which has an illuminating recess (not shown) through which an illuminating light beam 24 passes. The illuminating light beam 24 is produced for example by a laser of a microscope and deflected to the scanning unit 20 via one or more optical assemblies, for example reflectors, and/or one or more glass fibres. A carrier member 28 is movably suspended in a plane by means of a parallel spring linkage 26. The carrier member 28 carries a focusing lens system 30 onto which the illuminating light beam 24 is directed. The carrier member 28 which is movable in the plane is moved, via an electromagnetically operated actuator assembly which comprises a coil assembly 34 and a coil 36, perpendicularly to a center axis of the illuminating light beam 24, in relation to a reference position of the illuminating light beam 24.

Behind the focusing lens system 30 in the direction of the illuminating light beam 24 the scanning unit 20 is closed off by a front glass 38. Between the front glass 38 and the focusing lens system 30 is disposed an internal immersion medium 40. The illuminating light beam 24 is focused through the focusing lens system 30 and the focused illuminating light beam 42 is directed onto an object, particularly a specimen 44, which is carried by an object carrier 46. Thus, the illuminating recess, the focusing lens system 30, the internal immersion medium 40 and the front glass 38 are arranged one after the other in an illumination beam path of the illuminating light 24, viewed in the direction of the illuminating light 24.

The reference position of the illuminating light beam 24 relates to any desired fixedly predefined position of the illuminating beam 24, which is fixed and unchangeable in the embodiment shown in FIG. 1. However, even if the illuminating light beam 24 itself is moved, for example by coupling the illuminating light beam into the scanning unit 20 by means of an optically conductive fibre and by moving the optical fibre instead of or in addition to the movement of the focusing lens system (30), the reference position of the center axis of the illuminating light beam 24 is predefined by a fixedly predefined reference position of the optical fibre.

The internal immersion medium 40 helps to maximise the numerical aperture and the resolution that can be achieved using the scanning unit 20. Thus, even detection beams emanating from the specimen as a result of reflections or fluorescence effects and departing from the specimen at a particularly flat angle can be detected. The fact that the angle is particularly flat means in this context that the angle between the center axis of the illuminating light beam 24 and the detection beams is approximately 90°.

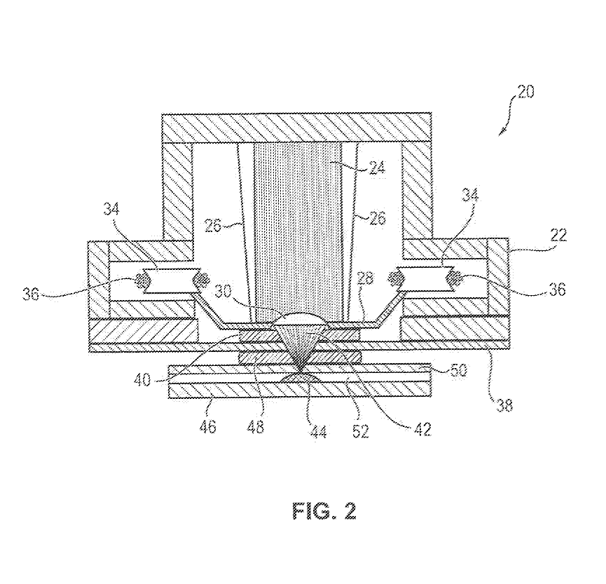

FIG. 2 shows the scanning unit 20 according to FIG. 1, in which the specimen 44 is covered by a cover glass 50. An external immersion medium 48 is introduced between the front glass 38 and the cover glass 50. Alternatively, the external immersion medium 48 can be omitted.

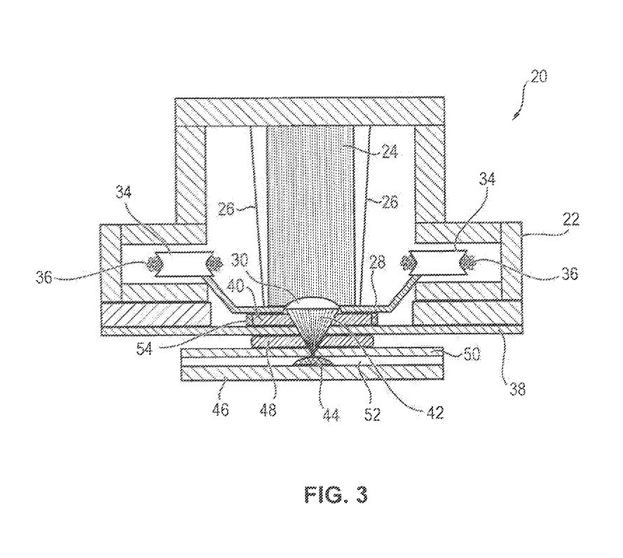

FIG. 3 shows the scanning unit according to FIG. 1, wherein the internal immersion medium 40 is bounded by a membrane 54 in the direction perpendicular to the center axis of the illuminating light beam 24. In this embodiment the membrane 54 is formed parallel to the center axis of the illuminating light beam 24. Alternatively, the membrane may also extend diagonally to the center axis or have a concave or convex curvature. The membrane 54 helps to ensure that the internal immersion medium 40 does not creep, flow or get flung out of the illumination beam path as a result of its own properties and/or as a result of the movement of the focusing lens system.

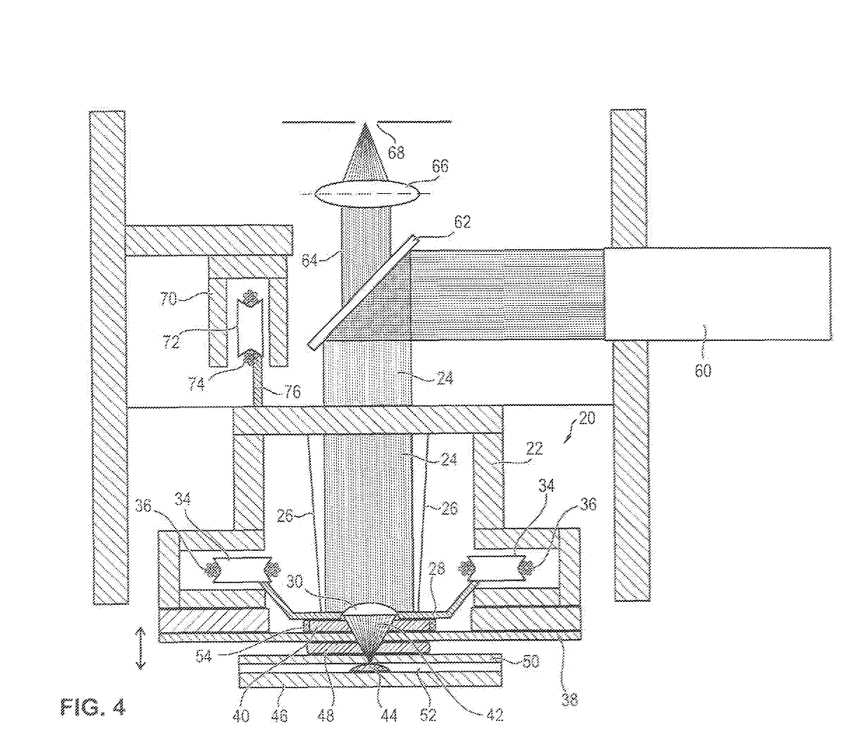

FIG. 4 shows the scanning unit 20 in a microscope. The microscope comprises a light source 60 which is preferably embodied as a laser light source. The light source 60 produces the illuminating light beam 24, which is directed through a beam splitter 62 to the scanning unit 20 and, in particular, onto the focusing lens system 30. Detection beams emanating from the specimen 44, particularly fluorescent light beams produced by fluorescent effects in the specimen 44, pass through the beam splitter 62 and are focussed by means of a detection lens 66 on a detection shutter 68 and picked up by a light-sensitive detector (not shown). The microscope comprises a vertical actuator assembly 70 which comprises a vertical coil assembly 72 and a vertical coil 74 and which moves a vertical carrier member 76 parallel to the illuminating light beam and perpendicularly to the plane in which the focusing lens system 30 is movable.

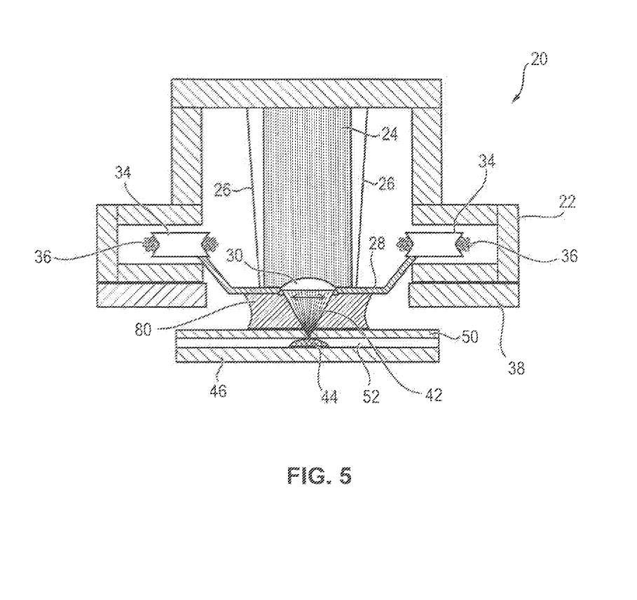

FIG. 5 shows an embodiment of the scanning unit 20 which does not comprise a front glass 38. In this embodiment, the immersion medium, particularly the external immersion medium 48, is introduced directly between the movable focusing lens system 30 and the specimen 44. In addition, the front glass 38 and/or the cover glass 50 may be provided, in which case the external immersion medium 48 is then in direct contact with the front glass 38 or the cover glass 50. Moreover, in the embodiments described hereinbefore, the external immersion medium 48 may be provided instead of or in addition to the internal immersion medium 40. For scanning the specimen, as great a distance as possible between the focusing lens system 30 and the cover glass 50 may help to ensure that the shear forces produced in the external immersion medium 48 are particularly small and thus have only a negligible effect on the controllability of the focusing lens system 30.

The immersion media preferably comprise oil, water and/or glycerol. The immersion media preferably have the lowest possible or highest possible viscosity. Using an immersion medium with the highest possible viscosity means that the movement of the focusing lens system 30 is affected as little as possible. This helps to ensure that the control and/or regulation of the movement of the focusing lens system 30 can be carried out as precisely as possible. A high viscosity immersion medium is preferred for the internal immersion medium 40. If an immersion medium with the highest possible viscosity is used, the membrane 54 is preferably provided. Using an immersion medium with the lowest possible viscosity means that it is possible to do without the membrane 54, without the immersion medium being flung out of the illumination beam path during the movement of the focusing lens system 30. Moreover, the probability of the undesirable formation of air bubbles in the immersion medium is reduced compared with the high viscosity immersion medium. This is particularly advantageous when the movement of the focusing lens system 30 takes place by resonance and is therefore particularly rapid. The low viscosity immersion medium is preferred for the internal immersion medium 40.

The surfaces of the focusing lens system 30 and/or the front glass 38 which are in direct contact with the internal immersion medium 40 and/or the surfaces of the focusing lens system 30, the front glass 38 and/or the cover glass that are in direct contact with the external immersion medium 48 preferably have a particularly high or particularly low roughness. A particularly low roughness, which can be achieved for example by polishing the corresponding surface, makes it possible to bring the focusing lens system 30 and the front glass 38 very close together, which helps to ensure that a refractive index of the immersion medium has particularly little influence on the properties of the microscope, particularly when the distance between the focusing lens system 30 and the front glass 38 is significantly less than the wavelength of the illumination light used. By contrast, a particularly rough surface, which can be obtained for example by forming a microscopic profile in the corresponding surfaces, helps to ensure that the corresponding immersion medium adheres particularly well to the corresponding surface.

The immersion medium preferably has the same refractive index as the focusing lens system 30 and the front glass 38. Moreover, the surfaces of the front glass 30 and focusing lens system 30 may be hardened to prevent damage to the surfaces moving relative to one another. Alternatively, the surfaces may also be made particularly soft, so that if the surfaces accidentally come into contact with one another this merely results in elastic deformation of the corresponding surface and not damage.

Microscopy processes in which the device according to the invention can be used, or observable effects that occur therein, include for example SRS (Stimulated Raman Scattering), FLIM (Fluorescence Lifetime Imaging), SHG (Second Harmonic Generation), FRAP (Fluorescence Recovery After Photobleaching), FRET (Fluorescence Resonance Energy Transfer) and FCS (Fluorescence Correlation Spectroscopy).

The invention is not limited to the embodiments described. For example, the embodiments may be combined with one another. For example, the vertical actuator assembly 70 may also be arranged in the scanning unit 20 or the microscope may be configured entirely without the vertical actuator assembly 70. Furthermore, in order to scan the specimen 44, instead of the focusing lens system 30 the illuminating light beam 24 may be moved, for example by means of an optical fibre, whose end facing the focusing lens system 30 is coupled to an actuator assembly. Instead of the electromagnetically operating actuator assembly another actuator assembly may be provided, for example one which comprises a least one, preferably several piezo-actuators. The scanning unit 20 may be a fixed component of the microscope or may be embodied as an objective for a conventional microscope with or without a scanning function, particularly as part of an objective turret. Moreover the scanning unit may be coupled to an outer actuator assembly which allows the scanning unit 20 to move over a large surface. In this embodiment, the illuminating light beam 24 is preferably coupled in through the fibre optic. In addition, the scanning unit 20 may be held on a stand, particularly a tripod. The light source 60 may be a laser which produces light of one or more discrete wavelengths or broadband light. Instead of the laser, a mercury vapour lamp may also be provided, for example. Instead of or in addition to the external immersion medium the focusing lens system 30 may also comprise a lens that is curved inwardly, viewed from the object.

### LIST OF REFERENCE NUMERALS

20 scanning unit
22 housing
24 illuminating light beam
26 parallel spring linkage
28 carrier member
30 focusing lens system
34 coil assembly
36 coil
38 front glass
40 internal immersion medium
42 focused illuminating light beam
44 specimen
46 slide
48 external immersion medium
50 cover glass
52 object layer
54 membrane
60 light source
62 beam splitter
64 detection light beam
66 detection lens
68 detection shutter
70 vertical actuator assembly
72 vertical coil assembly
74 vertical coil
76 vertical carrier member

What is claimed is:

1-13. (canceled)

14. A device for scanning an object, the device comprising:
a focusing lens system (30) which focuses an illuminating light beam (24) onto an area of the object that is to be examined;
an actuator assembly coupled to the focusing lens system (30), wherein the actuator assembly moves the focusing lens system (30) according to a predefined scanning pattern transversely to a center axis of the illuminating light beam (24) in a reference position of the illuminating light beam (24);
a front glass (38) arranged downstream of the focusing lens system (30) in the direction of the illuminating light beam (24); and
an internal immersion medium (40) disposed between the focusing lens system (30) and the front glass (38).

15. The device according to claim 14, wherein an interstice between the focusing lens system (30) and the front glass (38) is filled with the internal immersion medium (40).

16. The device according to claim 14, wherein the internal immersion medium (40) is bounded by a membrane (54) in a direction perpendicular to the illuminating light beam (24).

17. The device according to claim 14, wherein the internal immersion medium (40) has a predefined viscosity.

18. The device according to claim 14, wherein the internal immersion medium (40) is present in a gel-like state.

19. The device according to claim 14, wherein the internal immersion medium (40) has the same refractive index or approximately the same refractive index as the focusing lens system (30) and/or the front glass (38).

20. The device according to claim 14, wherein a surface of the front glass (38) is in contact with the internal immersion medium (40) and has a predefined roughness.

21. The device according to claim 20, wherein the surface of the front glass (38) in contact with the internal immersion medium (40) is hardened.

22. The device according to claim 14, wherein a surface of the focusing lens system (30) is in contact with the internal immersion medium (40) and has a predefined roughness.

23. The device according to claim 22, wherein the surface of the focusing lens system (30) in contact with the internal immersion medium (40) is hardened.

24. A microscope selected from the group consisting of a scanning microscope, a laser scanning microscope, and a confocal microscope, wherein the microscope comprises:
an illuminating light beam;
a focusing lens system (30) which focuses the illuminating light beam (24) onto an area of the object that is to be examined;
an actuator assembly coupled to the focusing lens system (30), wherein the actuator assembly moves the focusing lens system (30) according to a predefined scanning pattern transversely to a center axis of the illuminating light beam (24) in a reference position of the illuminating light beam (24);
a front glass (38) arranged downstream of the focusing lens system (30) in the direction of the illuminating light beam (24); and
an internal immersion medium (40) disposed between the focusing lens system (30) and the front glass (38).

25. A method for scanning an object comprising the steps of:
focusing an illuminating light beam onto an area of the object that is to be examined using a focusing lens system (30);
moving the focusing lens system (30) according to a predefined scanning pattern transversely to a center axis of the illuminating light beam (24) in a reference position of the illuminating light beam (24); and
providing an immersion medium (40, 48) between the focusing lens system (30) and the object in a direction of the illuminating light beam (24).

26. The method according to claim 25, further comprising the step of providing a cover glass between the immersion medium (40, 48) and the object in the direction of the illuminating light beam (24).

27. The method according to claim 25, wherein a front glass (38) is disposed downstream of the focusing lens system (30) in the direction of the illuminating light beam (24), and wherein the immersion medium includes an external immersion medium (48) provided between the front glass (38) and the object.

28. The method according to claim 27, wherein the immersion medium includes an internal immersion medium (40) provided between the focusing lens system (30) and the front glass (38) in the direction of the illuminating light beam (24).
